(19) United States
(12) Patent Application Publication
(10) Pub. No.: US 2003/0036408 A1
(43) Pub. Date: Feb. 20, 2003

(54) High-density radio access system

(76) Inventors: Lars Olof Johansson, Lynchburg, VA (US); Robert J. Gessel, Richardson, TX (US); Wallace Eugene Watson JR., Bedford, VA (US); Daniel Eric Carlson, Concord, VA (US); Benjamin O. Roderique, Goode, VA (US)

Correspondence Address: Daniel J. Chalker, Gardere Wynne Sewell, LLP, 3000 Thanksgiving Tower, 1601 Elm Street, Suite 3000, Dallas, TX, 75201-4767, US

(21) Appl. No.: 09/932,198

(22) Filed: Aug. 17, 2001

(51) Int. Cl. H04Q 7/20

(52) U.S. Cl. 455/560; 455/561; 455/562; 455/452; 455/453

(57) ABSTRACT

The present invention provides a high-density radio access system comprising an access point controller having a master connection handler and a sector quality of service handler, one or more multi-link controllers communicably coupled to the access point controller, one or more radio transceivers communicably coupled to each multi-link controller, a combiner communicably coupled to the one or more transceivers for each multi-link controller, and an omni directional antenna communicably coupled to the combiner. The present invention provides asymmetric allocation of resources, dynamic allocation of resources, load balancing in a multi-sector, high-density environment, and QoS leveling with categorization per cell, per sector, per system.

### FIELD OF THE INVENTION

The present invention relates generally to the field of communications and, more particularly, to a high-density radio access system.

### BACKGROUND OF THE INVENTION

Sporting and entertainment venues have typically been underserved with respect to handheld wireless technologies. This continues to be true even though entertainment is and will continue to be the largest volume of content delivered over the mobile Internet, and sports and entertainment revenue is very strong and fairly stable in the United States. These venues are underserved because of the cost to add high density radio access systems to older facilities and the complexity of installing the large number of access points that would be required to service the large crowds that attend sporting and entertainment events. In addition, high-density radio access points tend to work only in fixed public access networks (“PAN”) or piconet environments. As a result, the use of access points in large dynamic indoor/outdoor venues is not well established. Moreover, dynamic movement of a large number of handheld devices in such an access network has not been adequately addressed.

Accordingly, there is a need for a high-density radio access system that is scalable, economical and supports very large wireless multimedia networks that are flexible in distance (coverage area) and density. In addition, there is a need for a system that enables a new class of access points and servers capable of dynamically establishing, organizing, and managing large ad-hoc indoor and outdoor networks using radio technology.

### SUMMARY OF THE INVENTION

The present invention provides a high density radio access system that is scalable, economical and supports very large wireless multimedia networks, such as Bluetooth™, that are flexible in distance (coverage area) and density. The present invention also enables a new class of access points and servers capable of dynamically establishing, organizing, and managing large ad-hoc indoor and outdoor networks using radio technology. Although the present invention is applicable to any ad hoc radio access system, the present invention will be described in reference to large sporting or entertainment event venues using Bluetooth™ communication techniques for short distance wireless radio frequency (“RF”) communication applications. The Bluetooth™ Specification can be found at www.Bluetooth.com or www.Bluetooth.net. The Bluetooth™ network can provide higher speed throughput than two point five generation wireless networks and some third generation wireless networks. In addition, Bluetooth™ is more cost efficient than third generation wireless or 802.11 wireless infrastructures. As a result, the present invention has a low startup cost and is easy to install, maintain, plug & play, and scale up. The present invention offers a standardized, low-power, high-speed wireless interface that enables interactive voice and data communications from any enabled mobile device.

The present invention allows large venues, which are typically underserved with technology capability, to provide some or all of the following advanced multimedia technology services to large event audiences using handheld wireless devices: digitally encoded video or audio broadcasts; special on-site digitally encoded video feeds; broadcast announcements; sales of event food and/or merchandise; instant messaging; real-time statistics; surf specialized world-wide-web portals; map and location assistance; and voice communications. The present invention provides an economical way to enable a team, event, stadium, arena, or other facilities to deliver these advanced multimedia technology services to the event audiences in a uniquely economical way. As a result, the present invention simplifies logistical deployment and provides a more economical implementation of short-range wireless solutions, such as Bluetooth™.

Users use wireless enabled devices, such as cell phones, smart phones, pocket personal computers (“PPC”) or personal data assistants (“PDA”) to process advanced digitally encoded multimedia data from a short range wireless link such as Bluetooth™. A typical handheld device will preferably have voice capability and a simple liquid crystal display (“LCD”). The use of such devices provide the Facility/Team/Event Owners with additional revenue from rentals/sales of devices, increased merchandising of team/event, promotions concessions, internet sales, motivate ticket and merchandise sales, new high tech experience & additional convenience for facility services. The present invention can also provide PSTN/PLMN services and public wireless voice and data services. The present invention provides asymmetric allocation of resources and dynamic allocation of resources.

In addition, the present invention provides a high-density radio access system comprising an access point controller having a master connection handler and a sector quality of service handler, one or more multi-link controllers communicably coupled to the access point controller, one or more radio transceivers communicably coupled to each multi-link controller, a combiner communicably coupled to the one or more transceivers for each multi-link controller, and an omni directional antenna communicably coupled to the combiner. The present invention also includes the following Quality of Service (“QoS”) initiatives: load balancing in a multi-sector, high-density environment; and QoS leveling, QoS categorization per cell, per sector, per system. The present invention provides a new category of access points with (1) dynamic radio coverage capability, (2) optimal level of throughput to the users (maintain max data rate), (3) adapt to user movement and density, (4) variable backbone networking capability.

### BRIEF DESCRIPTION OF THE DRAWINGS

The above and further advantages of the invention may be better understood by referring to the following description in conjunction with the accompanying drawings, in which:

FIG. 1 is a block diagram of high-density radio access system in accordance with one embodiment of the present invention;

FIG. 2 is a block diagram of high-density radio access system in accordance with one embodiment of the present invention;

FIG. 3 is a block diagram showing the hardware platform of the high-density radio access system in accordance with one embodiment of the present invention;

FIG. 4 is a block diagram showing the software platform of the high-density radio access system in accordance with one embodiment of the present invention;

FIG. 5 is a diagram illustrating the sectorization of an access point in accordance with one embodiment of the present invention;

FIG. 6A is a block diagram showing a multi-link controller using directional antennas in accordance with one embodiment of the present invention;

FIG. 6B is a block diagram showing a multi-link controller using omni directional antennas in accordance with one embodiment of the present invention;

FIG. 7 is a block diagram of the interface between the multi-transceiver and the baseband controller in accordance with one embodiment of the present invention;

FIG. 8 is a block diagram of a load sharing scheme in accordance with the prior art; and

FIGS. 9A and 9B are block diagrams of a load-sharing scheme in accordance with one embodiment of the present invention.

### DETAILED DESCRIPTION OF THE INVENTION

While the making and using of various embodiments of the present invention are discussed in detail below, it should be appreciated that the present invention provides many applicable inventive concepts that can be embodied in a wide variety of specific contexts. The specific embodiments discussed herein are merely illustrative of specific ways to make and use the invention and do not delimit the scope of the invention. Although the present invention will be described in reference to large sporting or entertainment event venues using Bluetooth™ communication techniques for short distance wireless radio frequency (“RF”) communication applications, the present invention is applicable to any ad hoc radio access system.

The present invention provides a high density radio access system that is scalable, economical and supports very large wireless multimedia networks, such as Bluetooth™, that are flexible in distance (coverage area) and density. The present invention also enables a new class of access points and servers capable of dynamically establishing, organizing, and managing large ad-hoc indoor and outdoor networks using radio technology. The Bluetooth™ Specification can be found at www.Bluetooth.com or www.Bluetooth.net. The Bluetooth™ network can provide higher speed throughput than two point five generation wireless networks and some third generation wireless networks. In addition, Bluetooth™ can be more cost efficient than third generation wireless or 802.11 wireless infrastructures. As a result, the present invention has a low startup cost and is easy to install, maintain, upgrade, and scale up. The present invention offers a standardized, low-power, high-speed wireless interface that enables interactive voice and data communications from any enabled mobile device.

The Bluetooth™ radio is built into a small microchip and operates in a globally available frequency band ensuring communication compatibility worldwide. The Bluetooth™ specification has three defined power operation classes: lower power levels that cover the shorter personal area within a room up to 10 meters; and a higher power level that can cover a medium range up to 100 meters, such as within a home or public facility. Software controls and identity coding built into each microchip ensure that only those units preset by their owners can communicate. The Bluetooth™ wireless technology supports both point-to-point and point-to-multipoint connections. With the current specification, up to seven “slave” devices can be set to communicate with a “master” radio in one device. Several of these “piconets” can be established and linked together in ad-hoc “scatternets” to allow communication among continually flexible configurations. All devices in the same piconet have priority synchronization, but other devices can be set to enter at any time. The topology can best be described as a flexible, multiple piconet structure.

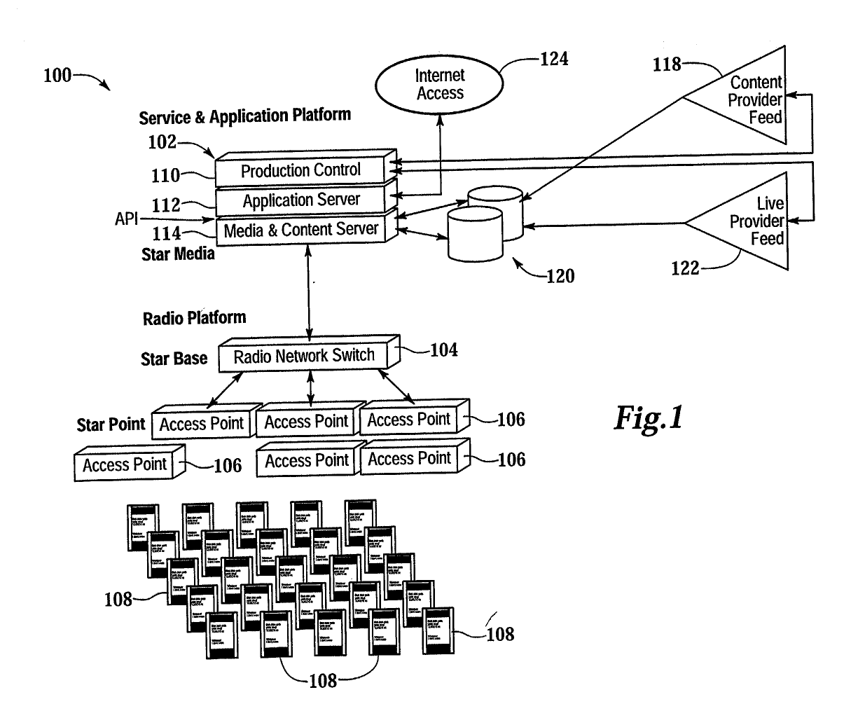

FIG. 1 is a block diagram of high-density radio access system in accordance with one embodiment of the present invention. The system 100 includes a service and application platform 102 communicably connected to one or more radio network switches 104. Each radio network switch 104 is then communicably coupled to one or more access points 106. Each access point 106 may communicate with one or more handheld devices 108 via a wireless communication link. The service and application platform 102 handles advanced configuration services, access management, databases, network performance management, handover management, location positioning, Ethernet network connections, network service access, gateway and proxy functions for PLMN/PSTN access, Internet access and security management. The service and application platform 102 includes a production control module 110, an application server 112 and a media and content server 114. The application server 112 is communicably coupled to the media and content server 114 via an application program interface (“API”) 116. A content provider feed 118 is communicably connected to the production control 110 and one or more databases 120. Similarly, a live provider feed 122 is communicably connected to the production control 110 and one or more databases 120. The application server 112 is communicably coupled to the Internet 124.

Content providers, advertisers/sponsors, event/venue owners, event/team owners, device provider and application/service provider can all use the present invention to benefit from the attendees at sporting and entertainment events. The system 100 allows large venues, such as auditoriums, concert halls, stadiums, race tracks, arenas, event centers, convention centers, malls, casinos, amusement parks, winter sports venues, museums, public places and golf courses, all of which are typically underserved with technology capability, to provide some or all of the following advanced multimedia technology services to large event audiences using handheld wireless devices 108: digitally encoded video or audio broadcasts; special on-site digitally encoded video feeds; broadcast announcements; sales of event food and/or merchandise; instant messaging; real-time statistics; surf specialized world-wide-web portals; map and location assistance; and voice communications within the network or to/from the PSTN/PLMN networks. The digitally encoded video and audio feeds may include instant replay, live TV, alternate perspective video (“helmet cam” or “catcher-cam” or “in-car” camera), or multi-player gaming. The handheld device may also include a digital camera that allows the user to take digital pictures. The present invention can enable a team, event, stadium, arena, or other facility to deliver these advanced wireless services to the event audiences. As a result, the present invention provides a lucrative value chain between content providers, application developers, service providers, venue owners, event/team owners, device providers and customers.

Users use wireless enabled handheld devices 108, such as cell phones, smart phones, pocket personal computers (“PPC”) or personal data assistants (“PDA”) to process advanced digitally encoded multimedia data from a short range wireless link such as Bluetooth™. A typical handheld device 108 will preferably have voice capability and a simple liquid crystal display (“LCD”). A typical handheld device 108 may also accept smart cards or provide two-way radio functions. If the handheld device 108 has a built in small digital camera, the user can store pictures on the facilities temporary www site for retrieval from home or upon leaving the venue (via CD or floppy). The handheld devices 108 can be JAVA enabled to quickly load and execute applications. The present invention also allows the venue owners to profile the users and conduct market analysis based on information obtained from the handheld devices 108. The use of such handheld devices 108 provide the venue owner with additional revenue from rentals/sales of devices, increased merchandising of team/event, m-commerce sales, promotions concessions, internet sales, motivate ticket and merchandise sales, new high tech experience & additional convenience for facility services.

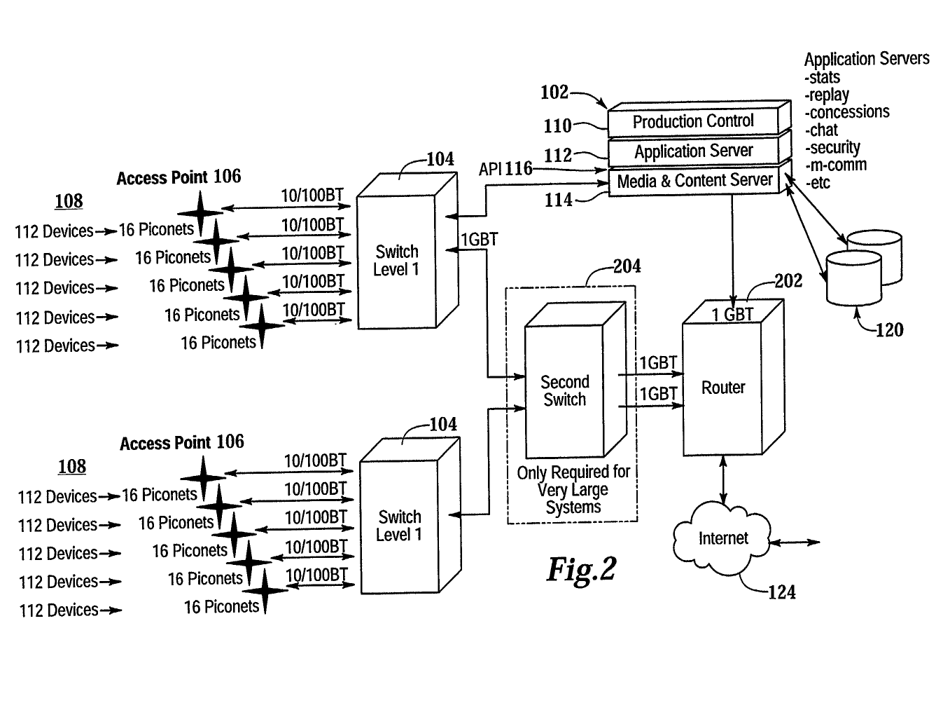

Now referring to FIG. 2, a block diagram of high-density radio access system in accordance with one embodiment of the present invention is shown. As also shown in FIG. 1, a service and application platform 102 includes a production control module 110, an application server 112 and a media and content server 114. The application server 112 is communicably coupled to the media and content server 114 via an application program interface (“API”) 116. The media and content server 114 is communicably coupled to one or more databases 120 and a router 202. The router is communicably coupled to the Internet 124. In very large systems, the router 202 is communicably coupled to a second switch 204, which is communicably coupled to one or more first switches 104. In smaller systems, the router 202 is communicably coupled to the one or more first switches 104. Each first switch 104 is then communicably coupled to one or more access points 106. Each access point 106 may communicate with one or more handheld devices 108 via a wireless communication link. As shown the communication links between the media and content server 114 and the router 202, between the router 202 and the second switch 204, and between the second switch 204 and the one or more first switches 104 are one gigabit Ethernet connections. The connections between the various access points 106 and the first level switches 104 can be 10/100 megabit Ethernet connections. Each access point 106 can be divided into (but not necessarily limited to), sixteen piconets with each piconet serving up to seven active handheld devices 108 for a total of one hundred twelve devices 108 per access point 106 as shown, but not necessarily not limited to 112.

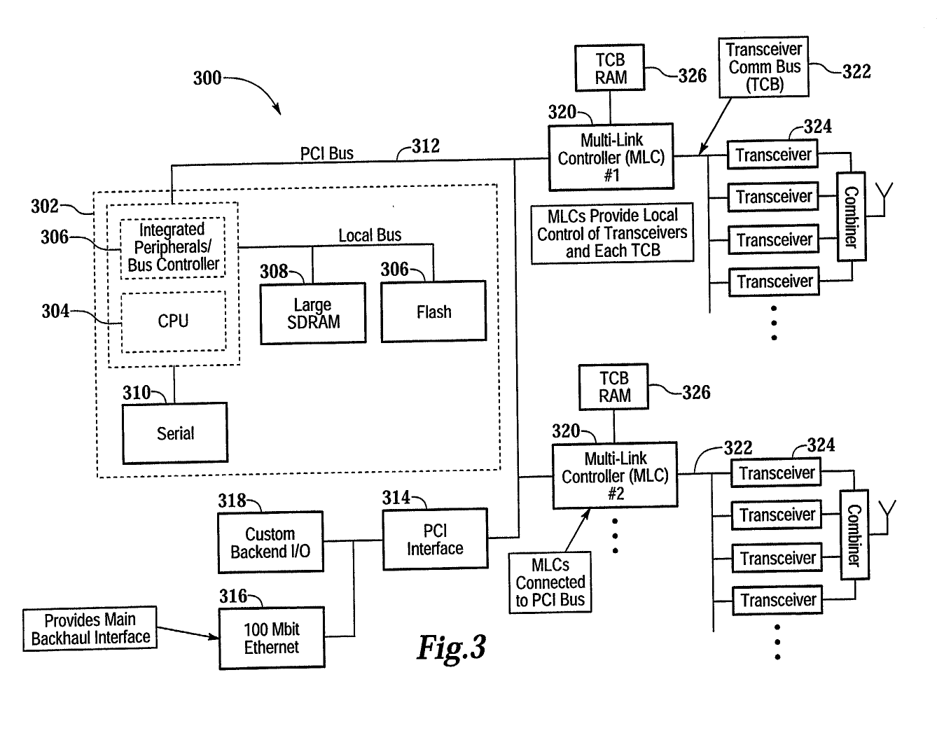

Referring now to FIG. 3, a block diagram showing the access point hardware platform 300 of the high-density radio access system in accordance with one embodiment of the present invention is shown. The access point controller 302 is controlled by the central processing unit (“CPU”) 304, which is accompanied by a bus peripheral controller 306. The access point controller 302 also includes flash memory 306, synchronous dynamic RAM (SDRAM) 308 and a serial port 310. The flash memory 306 is used for code storage as well as non-volatile configuration information. A large amount of fast SDRAM is shown to allow for the storage of protocol and link status data associated with all the users attached to the unit. The amount of SDRAM 308 is expandable to accommodate for more features as they are added to the system 300. The access point controller 302 is also connected to a PCI bus 312. The access point controller 302 can be upgraded easily through the use of configurable amounts of SDRAM 308 as previously mentioned to store user and program data. As the capabilities of the access point controller 302 are enhanced, more memory may be needed which drives the requirement to support different memory configurations. Driving the need for this feature are future software upgrades. The system 300 supports Trivial File Transfer Protocol (“TFTP”) to provide remote software upgrade capability. There is no need to send a technician to each site to load new software. Finally, the system 300 supports the routing of user data to various locations depending on the custom I/O requirements of the service provider's network. Custom I/O modules can be placed on the access point controller 302 to provide this capability. The software is then configured to route data to these I/O modules as needed. In general, as the system grows, the core software architecture remains constant while new features are added.

A 100 Megabit Ethernet controller 314 is attached to the Peripheral Component Interconnect (PCI) bus 312, which acts as the access point controller's 302 connection to the rest of the network. The 100 Megabit Ethernet controller 314 may be an integrated part of the CPU 304 instead of a PCI device. The access point controller 302 is not entirely reliant on Ethernet 316 as it's only connection to the rest of the network. Customized back-haul interfaces 318 can be added to the access point controller 302 such as fiber optic cable or even wireless 3G connections to accommodate for the needs of the provider.

One or more multi-link controllers (“MLC”) 320 are attached to the PCI bus 312. Each one of the MLC's 320 connects and manages one or more Bluetooth™ transceivers 324 grouped together on a common bus 322. The MLC 320 handles the interface between the access point controller 302 (main CPU) and the transceivers 324, as well as the traffic on the Transceiver Communications Bus (“TCB”) 322, which can be implemented as a universal serial bus (“USB”) bus. The TCB 322 can handle up to 127 transceivers 324 on a single bus. The MLC 320 contains a register set or memory that is used to store incoming and outgoing messages for the access point controller 302 and the transceivers 324. The MLC 320 stores messages and allows the access point controller 302 to access and retrieve the messages. The MLC 320 will also receive messages from the access point controller 302 and address those messages to the appropriate transceivers 324 for transmission to the handheld device. Message traffic between the access point controller 302 and the MLC 320 can be implemented using either polling or interrupts. If polling is used, the access point controller 302 would periodically determined if the MLC 320 has any data that needs to be sent to the access point controller 302 for processing. If interrupts are used, which is a more efficient process, the MLC 320 sends an interrupt to the access point controller 302 indicating that there is data that needs to be retrieved by the access point controller 302 for processing. As a result, the MLC 320 hides the details of the transceivers 324 from the access point controller 302. Without the MLC 320, the access point controller 302 would have to handle all the transceivers 324 in parallel. As a result, the MLC 320 reduces the processing load of the access point controller 302 and increases the flexibility of the architecture.

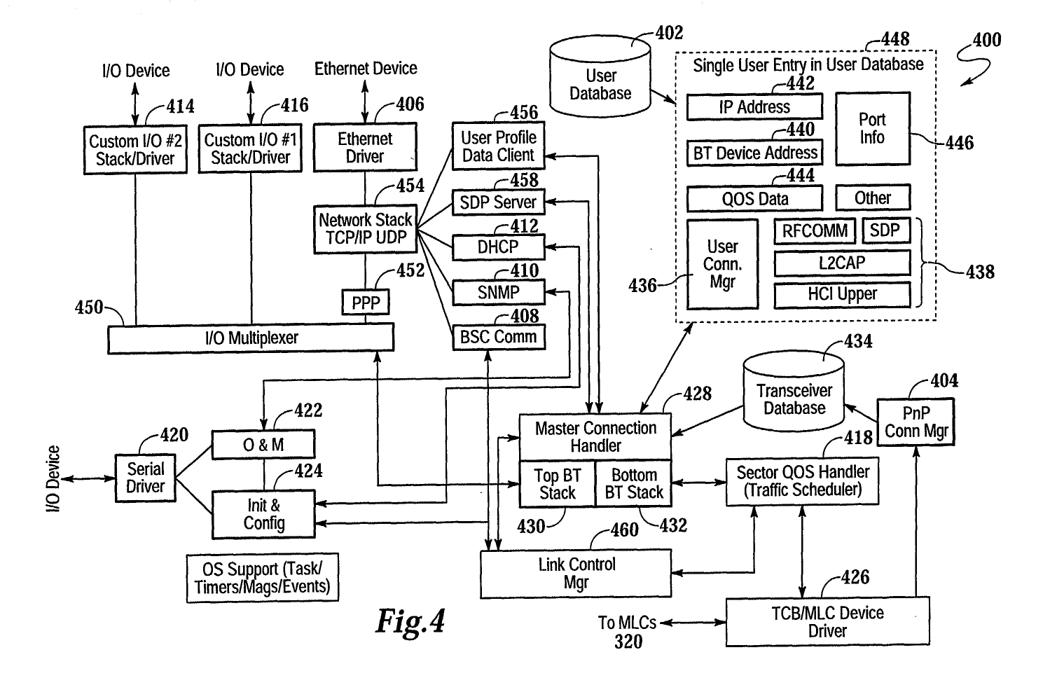

The MLC 320 also can discover the real-time addition or removal of a transceiver 324 without disrupting the system 300. When a new transceiver 324 is added, the MLC 320 receives an interrupt that changes the device status registers in the MLC 320 indicating that a new device has been detected. The MLC 320 assigns a memory access register to the device, which is used as the I/O port. Messages or data are then sent or received on that newly created port. This information is stored in the transceiver database 434 (FIG. 4) in the access point controller 302. As a result, the MLC 320 supports plug & play transceiver 324 device expansion. In addition, the modular design of the MLC 320 allows the high-density radio access system to be implemented and upgraded in stages to reduce cost and installation time.

With existing Bluetooth™ hardware, each transceiver 324 has it's own base band link controller, RAM, and flash memory, which handles the link manager protocol. If the base band link controller functionality for each transceiver 324 attached to the MLC 320 is moved into the MLC 320, this simplifies the transceiver 324 designs. Thus, the MLC 320 combines the link controllers of several of the transceivers 324 into one package and reduces the complexity of the system. At the same time, the MLC 320 allows for more control over such things like the frequency hopping sequence used to maximize the performance of the system.

Now referring to FIG. 4, a block diagram showing the software platform 400 of the high-density radio access system in accordance with one embodiment of the present invention is shown. The Bluetooth™ standard defines what protocols are to be used to transport IP based traffic; therefore, these protocols are supported in this system 400. In addition, the system 400 handles the Bluetooth™ connections for several users coming and going at random times, which drives the creation of user database 402. The user database 402 contains the identity and current status of each user, and that user's location in the stack. The user database 402 could also store the associated MLC/transceiver port information.

Transceivers 324 (FIG. 3) can be added or removed from the system 400, and therefore, a plug and play type connection manager 404 is used to auto-detect the configuration of each MLC 320 (FIG. 3). The Ethernet port 406 is used to support not only user data traffic, but also base station controller traffic (“BSC Comm”) 408, SNMP 410 and DHCP 412. The BSC Comm 408 handles control information regarding advanced features, such as inter access point hand-off and dynamic sector management within an access point. The BSC Comm 408 communicates with higher-level entities to provide coordination between access points. SNMP 410 is an administrative network protocol. DHCP 412 is a dynamic IP addressing protocol. The Service Discovery Protocol in Bluetooth™ (“SDP”) server 458 is a discovery protocol to discover what services are available on a device. Other support utilities, such as remote login shell and TFTP capability, are made possible through the use of Ethernet interface 406.

Driver software 414 and 416 is shown to support custom interface I/O for back-haul traffic. A Sector QoS Handler (“SQH”) or traffic scheduler 418 manages the quality of service provided to each user as well as each sector. All communications to and from the handheld device pass through the SQH 418, which essentially throttles all of the messages to and from the users to throttle each user's capacity y based on QoS parameters. The SQH 418 typically will have some type of queuing capability. Having the SQH 418 close to the access points (TBC/MLC device driver 426) reduces QoS overhead and prevents flooding the network with queries and dealing with backhand queuing mechanisms. The MLC 324 will also provide some local QoS functions to make sure that one transceiver does not get all the messages. User QoS agreements are also enforced through the L2CAP layer above the Host Computer Interface (“HCI”) layer in the Bluetooth™ protocol stack. The different types of QoS that the user may have the option to subscribe to is stored within the QoS data 444 within the user database 402. In addition, serial port 420 capabilities are available for local O&M support 422 and initialization and configuration 424.

For example, when a Bluetooth™ user tries to communicate with a web IP address pool outside of this network, the user is assigned an IP address. Thereafter, whenever a TCP/IP packet comes in with that particular IP address that has been dynamically assigned to the user, the user database 402 will know which user it is and the transceiver database 434 will know which transceiver 324 (FIG. 3) is currently in communication with that user and the Master Connection Handler (“MCH”) 428 will then send the messages to that particular MLC 320 (FIG. 3) using the SQH 418. The MLC 320 (FIG. 3) determines which transceiver 324 (FIG. 3) is currently handling that user and sends the messages to that transceiver 324 (FIG. 3), which will then send the messages to the user over a Bluetooth™ connection.

The MLC driver 426 uses a direct memory access (“DMA”) engine to minimize the load on the processor. This software architecture relies on two main design blocks to move and process Bluetooth™ data in the system. The MCH 428 moves the data through the standard Bluetooth™ protocol stack 430 and 432 in both directions that are associated with each master transceiver 324 in the system. The MCH 428 receives data from the bottom Bluetooth™ stack 432 as HCI layer and processed the data up through the stack to the point where the data looks like a PPP or IP packet. The MCH 428 places the processed messages on the top Bluetooth™ stack 430 for delivery to the P/O Multiplexer 450. The I/O Multiplexer 450 sends the message to the network via the PPP protocol 452, the network stack (TCP/IP and UDP) 454 and the Ethernet driver 406.

The MCH 428 knows what Bluetooth™ master transceiver 324 the data is associated with through the use of the master transceiver database 434. The current status of each user in the system is overseen by a user connection manager 436 and is stored in a user database 402 for use by various entities in the system. Information regarding the user's Bluetooth™ protocol stack 438, Bluetooth™ device address 440, IP address 442, QoS parameters 444, and port assignment information 446 are all stored as a single user entry 448 in the user database 402. The MCH 428 transfers Bluetooth™ data to and from the Sector QOS Handler (“SQH”) 418 to control the general flow of traffic down to the slave level.

The SQH 418 is essentially a traffic scheduler that has the ability to assign priorities between different sectors as well as between different users. Sector priorities are useful in network planning and configuration to balance the load between each sector. A Bluetooth™ Service Provider (“BSP”) may find that one sector of the access point or base station is busier than the other sectors. The SQH 418 can be configured to give a higher priority to users of this sector to meet required quality of service parameters. The SQH 418 can also enforce user priorities to provide higher priority to individual customers that may have paid for service of a certain quality. The SQH 418 then uses the MLC driver 426 to actually send and obtain Bluetooth™ connection data.

An operational transceiver 324 in the system will notify the CPU 304 that a slave connection request has come in. Upon the establishment of this first initial connection to the access point controller 302, a lot of the previously described information is collected. One main piece of information is the Bluetooth™ device address 440, which identifies the actual end user. This address could be used to obtain user profile/account policy data from either a local database or from a database located elsewhere in the infrastructure network to determine if the user shall be connected or denied, as well as QoS limits used when negotiating connection quality. The address identifies whom the data is ultimately associated with for the lifetime of the connection.

The system 400 also keeps track of what physical transceiver port the slave is attached to. This includes the MLC 320 as well as master transceiver's 324 location on the TCB 322. The SQH 418 and MLC driver software 426 use this information to determine where to obtain and send Bluetooth™ data for a particular transceiver 324. As was mentioned previously, data is then transferred between the SQH 418 and MCH 432. The MCH 432 processes the standard Bluetooth™ protocol stack. The lowest layer is the Host Controller Interface (“HCI”) layer data where basic connections are established and low-level security requests are processed. The next layer is the Logical Link Control and Adaptation Protocol (“L2CAP”) that assembles incoming packets, and determines who this user data is ultimately for. This data could be designated for the Bluetooth™ Service Discovery Protocol (“SDP”) layer, Bluetooth™ Serial Port Emulation (“RFCOMM”) layer, Bluetooth™ Network Encapsulation Protocol (“BNEP”), or maybe some other vendor specific Bluetooth™ protocol. The SDP layer is used to discover what services are available on a device; in this case the services that are available on the access point or base station. The user can then request to utilize one of these services, which will most likely be RFCOMM or an IP packet encapsulation protocol. RFCOMM is currently the standard means of establishing an IP based “network” connection and is defined by the LAN Access Profile in the Bluetooth™ specification. Data travelling through RFCOMM is sent to the I/O Multiplexer block 450, which is responsible for routing the data to the correct destination. Typically this destination will be the PPP 452 and TCP/IP stack 454, which sends data out on the Ethernet network to some destination. However, some BSP setups may have custom back-haul interfaces 414 and 416, such as fiber or cellular wireless to provide network access. Some BSP's may even have special services that are provided through these I/O ports 414 and 416. The I/O Multiplexer 450 is aware of how the user is configured and will route the data appropriately.

Services other than Bluetooth™ user data are supported through the Ethernet interface 406. Connection registration relies on user profile data to determine if the Bluetooth™ device requesting a new connection should be allowed. The User Profile Data Client 456 will access a local database as well as a central data base server located elsewhere in the network to support this registration activity using the Ethernet interface 406. Another “connection time” activity carried out by a user slave device will be to make an access to the local SDP server 458. As was mentioned earlier the SDP server 458 determines what Bluetooth™ services are available through this access point or base station. It may be necessary for the SDP server 458 to be configured and updated to reflect the current status of the network via the Ethernet interface 406. DHCP 412 services are provided through the Ethernet interface 406 to support IP address configuration of both the access point (base station) and the users connected to the access point (base station). SNMP 410 is another service supported by the access point (base station) that provides the network administrator with the O&M ability to monitor and control the status of the access point (base station). Another interface block called BSC Comm 408 allows control information regarding advanced features such as handoffs and dynamic sector management to be transferred between the station's Link Control Manager (“LCM”) 460 and the BSC. Profiling of sector activity can be logged using this interface, which allows the administrator to analyze the activity data and optimize the configuration of the access point (base station) network. The LCM 460 acts as an interface to handle requests to establish or break a connection (call set up and tear down).

As has been previously discussed, the architecture presented isolates the transceiver section from the rest of the design through the use of the interface block called the MLC 320. This is important because it minimizes the amount of change that the remainder of the system undertakes as a result of upgrading the transceiver capabilities of the access point (base station). As the user base of a BSP increases, the provider would naturally like to be able to handle more users with the same access point (base station). A Bluetooth™ master is only capable of handling 7 active slaves at one time and this therefore imposes a limit on the capacity of a single transceiver 324. The hardware/software architecture in the access point (base station) is designed to accommodate this limit by allowing transceiver modules to be added to the system. The MLC 320 and TCB 426 are aware of what transceivers are attached and notify the main CPU of what the current configuration is. It is the responsibility of the plug and play connection manager 404 to monitor this configuration, update the master transceiver database, and notify the MCH 428 and SQH 418 that a new master transceiver physical port is present. The MCH 320 can then establish communications with the new transceiver 324, determine the transceiver's type and Bluetooth™ air interface revision number, and then start the correct Bluetooth™ protocol stacks to configure the device, and begin servicing slave connections. The TCB hardware interface 426 may be designed such that the transceivers are “hot swappable” allowing these O&M tasks to be completed on a live system if needed.

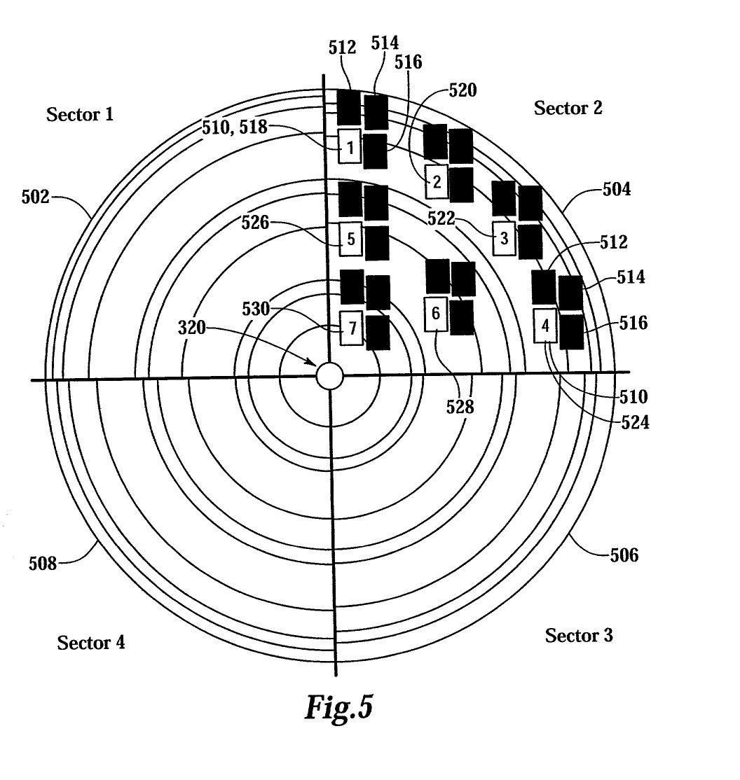

Referring now to FIG. 5, a diagram illustrating the sectorization of an access point in accordance with one embodiment of the present invention is shown. The access point or MLC 320 can have up to four sectors 502, 504, 506 and 508, each sector 502, 504, 506 and 508 can support up to four piconets 510, 512, 514 and 516, each piconet 510, 512, 514 and 516 can handle seven active slaves 518, 520, 522, 524, 526, 528 and 530, each piconet 510, 512, 514 and 516 can handle 255 parked slaves. The MLCs 320 are asymmetrically scalable such that each sector 502, 504, 506 and 508 within the MLC 320 can be configured with different numbers of piconets 510, 512, 514 and 516, up to a maximum of four. The MLC 320 evenly distribute loading among the piconets 510, 512, 514 and 516 within a sector 502, 504, 506 and 508 in order to better handle bandwidth demands. The MLC 320 provides electronic allocation of transceiver capacity by evenly distributing new devices between all the piconets 510, 512, 514 and 516 to ensure QoS (load sharing). The MLC 320 can also limit the number of active devices per piconet 510, 512, 514 and 516 to ensure QoS. This ensures QoS for applications that require high bandwidth. Each piconet 510, 512, 514 and 516 within the sector 502, 504, 506 and 508 can allow different numbers of active devices. The transceivers 324 are scalable, upgradeable and are plug and play. The memory and backbone solutions are also scalable. The wireless backbone can be use any high bandwidth wireless point-to-point solution capable of handling the traffic capacity. In addition repeaters can be used to extend wireless backbone range. Moreover, low power access points 300 can be operated by battery and/or solar power for remote or outdoor locations at the same time utilizing the Bluetooth scatternet or other wireless backbone connection for remote operation.

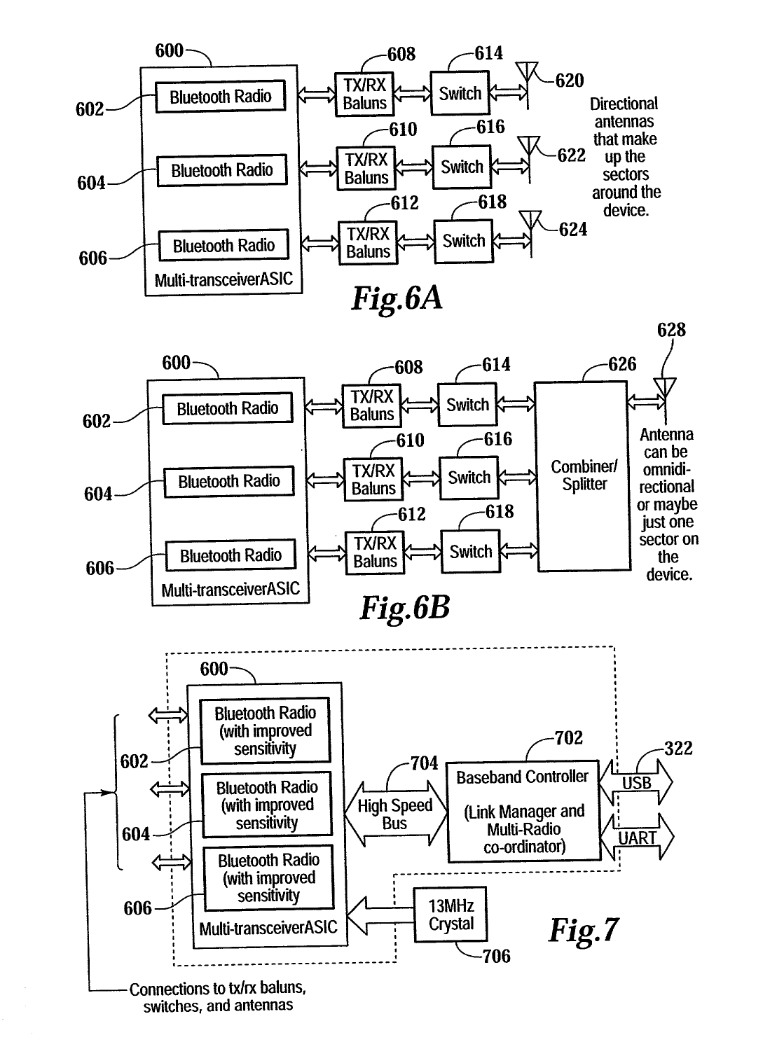

As previously described in FIG. 3, individual transceivers 324 are connected to a TCB 322. Each MLC 320 in the system is responsible for passing data between all transceivers 324 attached to it and the main CPU 304. The MLC 320 will preferably contain a common link controller with RAM 326 and flash to handle a specified number of transceivers 324. Depending on how the MLC 320 is designed, the TCB 322 may be either individual connections to each transceiver modem 324 (See FIG. 6A), or a common bus that handles the traffic rate required to support all the connected transceivers 324 (See FIG. 6B). The baseband or link controller 704 may be part of each transceiver 324 in the system or as part of the MLC 324 (See FIG. 7). A common feature of most Bluetooth™ transceiver link controllers is USB support running at 12 Mb/s. Rough calculations assuming a 1 Mb/s Bluetooth™ link would limit the number of devices on a TCB 322 to 12. However, the number would actually be slightly higher since the actual Bluetooth™ data rate is less due to protocol overhead. This would allow the TCB 322 to be a common bus for all transceivers 324 attached to the same MLC 320. The MLC 320 could have the ability to buffer data in a local RAM 326 until it can be sent to the main CPU memory (306 or 308) or to a transceiver 324. This architecture minimizes the impact that an evolving MLC 320 will have on the rest of the system. It does not matter to the rest of the system if the MLC 320 is a simple USB hub with memory buffer or a complete multi-link Bluetooth™ controller with RAM and flash.

Now referring to FIG. 6A, a block diagram showing a multi-link controller using directional antennas in accordance with one embodiment of the present invention is shown. The multi-transceiver ASIC 600 is part of the multi-link controller 320 (FIG. 3) and contains one or more Bluetooth™ radios 602, 604 and 606. Radio 602 is communicably coupled to a transmitter/receiver 608, which is communicably coupled to a switch 614, which is communicably coupled to a directional antenna 620. Similarly, radio 604 is communicably coupled to a transmitter/receiver 610, which is communicably coupled to a switch 616, which is communicably coupled to a directional antenna 622; and radio 606 is communicably coupled to a transmitter/receiver 612, which is communicably coupled to a switch 618, which is communicably coupled to a directional antenna 624.

Referring now to FIG. 6B, a block diagram showing a multi-link controller using omni directional antennas in accordance with one embodiment of the present invention is shown. The multi-transceiver ASIC 600 is part of the multi-link controller 320 (FIG. 3) and contains one or more Bluetooth™ radios 602, 604 and 606. Radio 602 is communicably coupled to a transmitter/receiver 608, which is communicably coupled to a switch 614. Similarly, radio 604 is communicably coupled to a transmitter/receiver 610, which is communicably coupled to a switch 616; and radio 606 is communicably coupled to a transmitter/receiver 612, which is communicably coupled to a switch 618. Switches 614, 616 and 618 are communicably coupled to a combiner/splitter 626, which is communicably connected to an omni directional antenna 628.

Now referring to FIG. 7, a block diagram of the interface between the multi-transceiver and the baseband controller in accordance with one embodiment of the present invention is shown. The multi-transceiver ASIC 600 is part of the multi-link controller 320 (FIG. 3) and contains one or more Bluetooth™ radios with improved sensitivity 602, 604 and 606. The multi-transceiver ASIC 600 is communicably coupled to a baseband controller 702 via a high-speed bus 704. The multi-transceiver ASIC 600 is also communicably coupled to a 13 MHz crystal clock 706. The baseband controller 702 is connected to the TCB bus 322 (FIG. 3), which is shown to be a USB bus. All of these elements, except for the clock 706, which is usually external, can be integrated into a one or more chips or a printed circuit board.

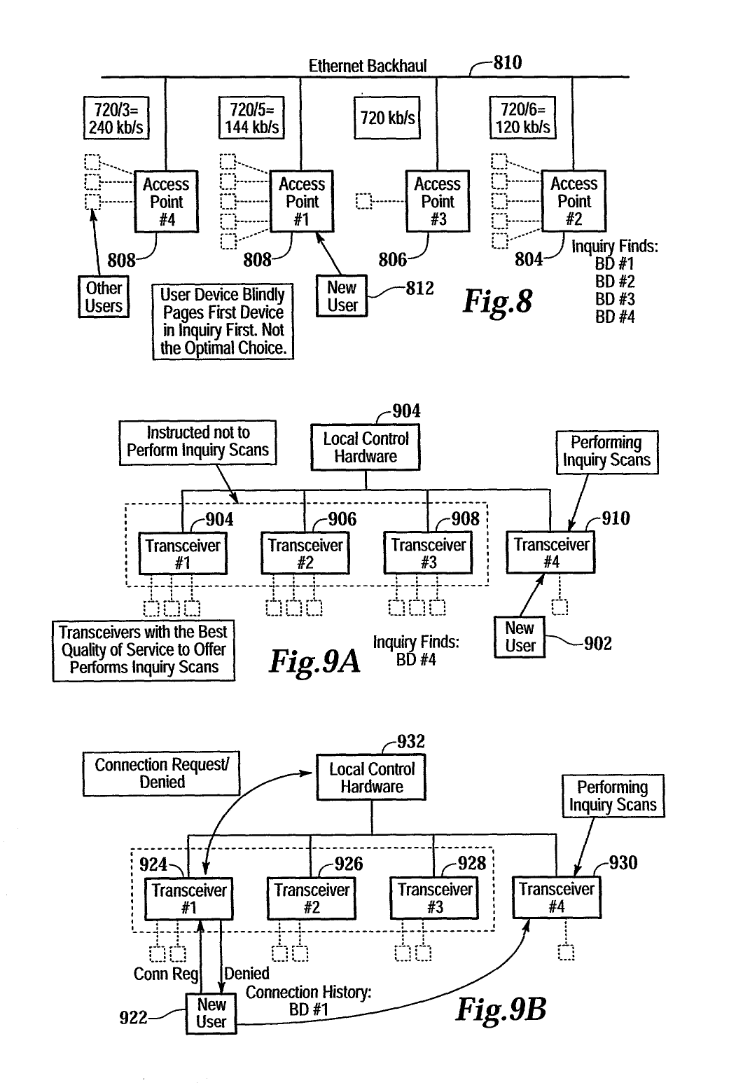

Now referring to FIG. 8A, a block diagram of a load-sharing scheme in accordance with the prior art is shown. A typical Bluetooth™ “access point”, such as 802, 804, 806 or 808, contains a single master transceiver that can communicate with up to seven user slave devices. Each access point 802, 804, 806 and 808 are connected to an Ethernet back-haul 810. The roughly 720 kBit/sec downlink data transfer rate is shared among the seven users. For example, the downlink data rate for access point number one 802 is 144 kBit/sec because there are five connected users; the downlink data rate for access point number two 804 is 120 kBit/sec because there are six connected users; the downlink data rate for access point number three 806 is 720 kBit/sec because there is one connected user; and the downlink data rate for access point number four 808 is 240 kBit/sec because there are three connected users. Although this may be sufficient for a small personal office environment with just a handful of users, it is not a reasonable solution for a high-density environment where hundreds or thousands of users require Bluetooth™ access. The limit of seven slave devices is stated in the Bluetooth™ specification and cannot be changed. Therefore, more access point transceivers must be utilized to accommodate the larger number of potential slave users.

The Bluetooth™ device connection process typically involves the user 812 first sending out a Bluetooth™ inquiry message. Normally, all of the access point transceivers 802, 804, 806 and 808 would be looking for these inquiry messages by performing inquiry scans. Upon seeing the inquiry messages they would then respond back declaring their presence. The user device 812 would then know what transceivers 802, 804, 806 and 808 are present and can proceed to page one of them.

Now referring back to the present invention, FIGS. 9A and 9B are block diagrams of a load-sharing scheme in accordance with one embodiment of the present invention. To maximize the QoS provided to a new user 902, the access point or transceiver 904, 906, 908 or 910 with the least number of slave devices in its piconet should be chosen. The new user's device 902 does not know how many devices are already attached to each available access point transceiver 904, 906, 908 or 910. If the new user 902 sends out Bluetooth™ Inquiry messages and then connects to just any of the visible access point transceivers 904, 906, 908 or 910, it is quite possible that this user 902 will join a piconet with several users already present. The end user 902 will not be realizing the best QoS available by the system in such a case.

At connection time, the user device 902 merely sends out inquiry and page messages to attach to the system. It is up to this device 902 to decide which access point transceiver to page. Without assistance from the network side the user device can not just pick the access point transceiver that has the least congested piconet. The assistance needed can come in the form of a high density Bluetooth™ local control hardware and associated software 912 that provides synchronization and control over several integrated Bluetooth™ transceivers 904, 906, 908 and 910.

Integrated Bluetooth™ transceivers 904, 906, 908 and 910 can be scheduled to perform inquiry scans in a distributed fashion such that over time the transceiver responding to an inquiry is the transceiver 904, 906, 908 or 910 with the most available bandwidth. This increases the probability that the loading in each piconet will be balanced and the probability that new user devices 902 will tend to connect to the transceiver 904, 906, 908 or 910, which has the best quality of service to offer. Also, since the inquiry scans are distributed across several access point (base station) transceivers 904, 906, 908 and 910 over time, the hit taken by each transceiver 904, 906, 908 and 910 due to executing the inquiry scans is reduced.

As shown in FIG. 9B, this connection time load balancing can be taken a step further. It is not mandatory for a user device 922 to perform an inquiry first, and therefore may send a page message directly to a specific Bluetooth™ transceiver 924. The local access point (base station) control hardware 932 will receive notification of this connection request from the transceiver 924. Upon examining the loading on the other transceivers 926, 928 and 930 in the access point (base station), the controller 932 may chose to deny the connection request. This could be because it has to maintain the current quality of service provided by that transceiver 924 to its current users, or because other transceivers 926, 928 and 930 in the access point (base station) can provide a better quality of service.

The user device 922 is then forced to find and connect to another transceiver 930. The users new inquiry will return a access point (base station) transceiver 930 available for connection as was discussed in the paragraphs above. By performing this denial of connection action, uniform loading across all access point (base station) transceivers 924, 926, 928 and 930 is enforced. The controller 932 may be implemented using the SQH 418 (FIG. 4) and MCH 428 (FIG. 4). QoS can also be improved by deciding not to transmit on the broadcast channel when a particular sector is overloaded with transmissions going on with specific users.

A piconet or channel in Bluetooth™ can actually be described as the sequence of carrier frequencies used for communications between a master and slave device over time. The master and all slaves attached to that master hop 1600 times a second together while passing data back and forth. Bluetooth™ implements a frequency-hopping scheme that is pseudo-random. In basic terms pseudo-random means a sequence that appears random, but is actually predictable when some of the entities used to generate the “random” sequence are known. The random sequence of frequency values is taken from a defined set of 79 available frequencies. All devices derive their hopping sequence from this pre-defined set. As the number of devices in the same geographical area increases, the chances of two pseudo-random sequences hitting the same carrier frequency increase. This induces a collision or interference condition that causes the data transferred on the channel at that time to be corrupted. A retransmission of this data will then have to occur, thus decreasing the user's end data rate, and therefore, the user's quality of service.

Knowing this information it is easy to understand that a compromise must be made between the number of masters in a single area (interference/collisions), and the number of users that must be supported. Some studies indicate that there should be less than roughly 10 masters in a single area to prevent the data rate from declining when more masters are added. This study assumes the devices all have high quality RF sections, which will not be the case in the field. Four to five devices are actually more realistic.

One approach to addressing this problem is to attempt to control the frequency hopping sequences used by the masters in the same geographic region. The goal is to minimize the number of collisions between piconets and therefore increase each channel's data throughput. The entities mentioned above used to derive the sequence of hop frequencies used in a Bluetooth™ Channel/Piconet are the master's Bluetooth™ device address and the value of the master's clock. However, it should be emphasized here that both the master and slave devices derive the sequence using this algorithm and the master's information.

The Bluetooth™ device address is composed of three parts. The upper address part (“UAP”), lower address part (“LAP”), and the non-significant address part (“NAP”). The UAP and NAP define the device manufacturer's ID, and cannot be changed. The LAP acts as a serial number for the physical device, and is assigned by the device manufacturer. The LAP and UAP are used with the frequency-hopping algorithm. So, this device address really can't be dynamically changed since it uniquely identifies the device in the “Bluetooth™ domain”.

The other controlling entity, which defines the channel or frequency hopping sequence, is the master's clock as previously mentioned. Consider a master device with a piconet attached, piconet A. Now consider another group of slaves, piconet B, attached to the same master link controller, which follows the same exact hopping sequence as the first piconet, but is delayed in time. Using the concept of shifting the phase of the master's clock, seven slaves are attached to a single master, and the aggregate bandwidth of the entire picocell would be the sum total of each piconet's bandwidth. This requires a special implementation of a Bluetooth™ link controller capable of managing piconets on a clock-phase basis as well as able to process more than one carrier frequency in the RF section. From the slave's perspective there is nothing strange going on. It is merely a member of a piconet. There are other piconets attached to the same master that are merely shifted in time. The act of executing a page or inquiry would be applied to all piconets attached to that master.

Using this approach produces a larger overall data rate at the access point. However, just like with the several distinct masters scenario in the same geographic region, this approach will have similar channel collision issues. There are only 79 hop frequencies available. Eventually the hop frequency of piconet A will match the hop frequency of piconet B resulting in co-channel interference resulting in data corruption regardless if they are following the same hop sequence.

As described above, the present invention provides asymmetric allocation of resources and dynamic allocation of resources. In addition, the present invention includes the following Quality of Service (“QoS”) initiatives: load balancing in a multi-sector, high density environment; and QoS leveling, categorization per cell, per sector, per system. The present invention provides (1) a new category of access points with dynamic radio coverage capability, optimal level of throughput to the users (maintain max data rate), adapt to user movement and density, variable backbone networking capability, such as power line communications, operation in remote sites via battery operation plus scatternet.

Although preferred embodiments of the present invention have been described in detail, it will be understood by those skilled in the art that various modifications can be made therein without departing from the spirit and scope of the invention as set forth in the appended claims.

What is claimed is:

1. A radio access system high comprising:
an access point controller having a master connection handler and a sector quality of service handler;
one or more multi-link controllers communicably coupled to the access point;
one or more transceivers communicably coupled to each multi-link controller;
a combiner communicably coupled to the one or more transceivers for each multi-link controller; and
an omni directional antenna communicably coupled to the combiner.

2. The system as recited in claim 1, wherein each multi-link controller comprises:
a first interface communicably coupled to the access point controller;
a baseband controller communicably coupled to the first interface; and
a multi-transceiver ASIC communicably coupled to the baseband controller, the multi-transceiver ASIC having a radio communicably coupled to each transceiver.

3. The system as recited in claim 2, wherein the baseband controller manages two or more piconets on a clock-phase basis.

4. The system as recited in claim 1, further comprising a memory communicably coupled to each multi-link controller.

5. The system as recited in claim 1, wherein the access point controller further comprises:
a transceiver connection manager; and
a transceiver database communicably coupled to the transceiver connection manager and the master connection handler.

6. The system as recited in claim 1, wherein the master connection handler and the sector quality of service handler perform load-balancing functions.

7. The system as recited in claim 1, wherein the system is installed in a sporting venue.

8. The system as recited in claim 1, wherein the system is installed in an entertainment venue.

9. The system as recited in claim 1, wherein the access point controller further comprises a user database communicably coupled to the master connection handler.

10. The system as recited in claim 1, wherein the one or more multi-link controllers are communicably coupled to the access point controller via a PCI bus.

11. The system as recited in claim 1, wherein the one or more transceivers are communicably coupled to each multi-link controller via a USB bus.

12. The system as recited in claim 1, wherein the access point controller comprises:
a bus controller;
a central processing unit communicably coupled to the bus controller; and
a memory communicably coupled to the bus controller.

13. The system as recited in claim 1, further comprising an Ethernet interface communicably coupled to the access point.

14. The system as recited in claim 1, wherein the system uses a Bluetooth communications protocol.
